(19) United States
(12) Patent Application Publication
(10) Pub. No.: US 2019/0391265 A1
(43) Pub. Date: Dec. 26, 2019

(54) 3D SENSING SYSTEM

(71) Applicant: ACER INCORPORATED, New Taipei City (TW)

(72) Inventors: Jia-Yu Lin, New Taipei City (TW); Chih-Chiang Chen, New Taipei City (TW)

(21) Appl. No.: 16/132,451

(22) Filed: Sep. 16, 2018

(30) Foreign Application Priority Data
Jun. 26, 2018 (TW) 107121782

(51) Int. Cl. G01S 17/08; G02B 26/12; G01S 17/02; G06T 7/55; H04N 5/225

(52) U.S. Cl. CPC G01S 17/08; G02B 26/12; H04N 5/2256; G06T 7/55; G01S 17/023

(57) ABSTRACT

In a 3D sensing system, a light module includes one or multiple light sources, and one or multiple MEMS mirrors are disposed on a rotatable reflector plate for reflecting light provided by the one or multiple light sources, respectively. A camera is configured to record one or multiple light spots when the light provided by the one or multiple light sources is reflected on a target. A micro controller unit is configured to acquire the distance between the target and the rotatable reflector plate according to a pitch of two adjacent light spots among the one or multiple light spots.

### CROSS REFERENCE TO RELATED APPLICATION

This application claims priority of Taiwan Application No. 107121782 filed on 2018 Jun. 26.

### BACKGROUND OF THE INVENTION

### 1. Field of the Invention

The present invention is related to a 3D sensing system, and more particularly, to a 3D sensing system using MEMS techniques.

### 2. Description of the Prior Art

As technology advances, 3D sensing has been introduced into new applications such as advanced driver assistance systems (ADAS), virtual reality (VR), augmented reality (AR), unman stores and facial recognition. There are a variety of technologies for digitally acquiring the shape of a 3D object. For example, a triangulation-based 3D sensing system utilizes a stereoscopic technique, a structured light technique or a laser triangulation technique. A time-delay based 3D sensing system utilizes a time-of-flight (ToF) technique or an interferometry technique.

A triangulation-based 3D sensing system is required to identify and calculate grating deformation. A ToF 3D sensing system is required to record and calculate the round-trip time of a pulse of laser for conversion into distance. Therefore, there is a need fora 3D sensing system which does not require complex 3D computation.

### SUMMARY OF THE INVENTION

The present invention provides a 3D sensing system which includes a light module, a rotatable reflector plate, a camera, and a micro controller unit. The light module includes one or multiple light sources. The rotatable reflector plate includes one or multiple MEMS scanning mirrors arranged to reflect light provided by the one or multiple light sources. The camera is configured to record one or multiple light spots present on a target when the light provided by the one or multiple light sources is reflected on the target. The micro controller unit is configured to acquire a distance between the target and the rotatable reflector plate according to a pitch of two adjacent light spots among the one or multiple light spots.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram illustrating a 3D sensing system according to an embodiment of the present invention. FIGS. 2 and 3 are diagrams illustrating the operation of an MEMS scanning mirror according to an embodiment of the present invention.

FIGS. 4-6 are diagrams illustrating the operation of a 3D sensing system when determining distance based on the pitch of light spots according to an embodiment of the present invention.

FIG. 7 is a diagram illustrating the scan method of a 3D sensing system according to an embodiment of the present invention.

FIG. 8 is a diagram illustrating the scan method of a 3D sensing system according to another embodiment of the present invention.

FIG. 9 is a diagram illustrating the scan method of a 3D sensing system according to another embodiment of the present invention.

FIG. 10 is a diagram illustrating the scan method of a 3D sensing system according to another embodiment of the present invention.

FIG. 11 is a diagram illustrating the operation of a 3D sensing system when determining a scan range according to an embodiment of the present invention.

FIG. 12 is a diagram illustrating the operation of a 3D sensing system when determining a scan range according to another embodiment of the present invention.

### DETAILED DESCRIPTION

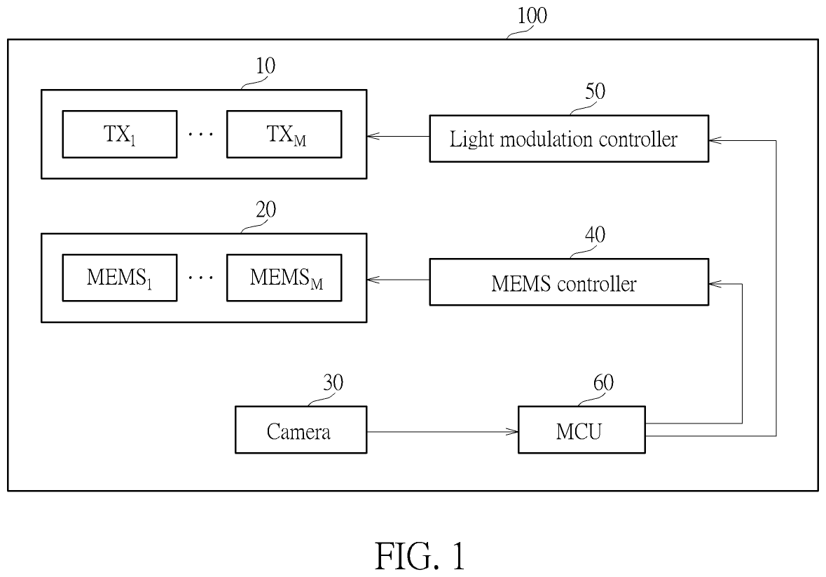

FIG. 1 is a functional diagram illustrating a 3D sensing system 100 according to an embodiment of the present invention. The 3D sensing system 100 includes a light module 10, a rotatable reflector plate 20, a camera 30, a micro electro mechanical system (MEMS) scanning mirror controller 40, a light modulation controller 50, and a micro controller unit (MCU) 60. The light module 10 includes one or multiple light sources TX₁˜TX_{M}, and the rotatable reflector plate 20 includes one or multiple MEMS scanning mirrors MEMS₁˜MEMS_{M} arranged to reflect the light provided by the one or multiple light sources TX₁˜TX_{M}, wherein M is a positive integer. The MEMS controller 40 is configured to control the angle of the rotatable reflector plate 20. The light modulation controller 50 is configured to turn on or turn off the light module 10. The MCU 60 is configured to control the camera 30, the MEMS controller 40 and the light modulation controller 50 so as to synchronize the operations of the light module 10, the rotatable reflector plate 20 and the camera 30, and configured to acquire the distance between a target and the 3D sensing system 100 according to photos taken by the camera 30.

The MEMS technology is a process technology in which mechanical and electro-mechanical devices, structures, circuits, sensors or actuators are constructed on silicon wafers using special micro-fabrication techniques. The operation of MEMS devices may be actuated using electrostriction, thermoelectric, piezoelectric or piezoresistive effect. FIGS. 2 and 3 are diagrams illustrating the operation of an MEMS scanning mirror according to an embodiment of the present invention. Each MEMS scanning mirror disposed on the rotatable reflector plate 20 may include a micro-electronic coil 23, a reflecting mirror 24, a reflecting mirror flexure suspension 25, a gimbal frame 26, and a gimbal frame flexure suspension 27. By inputting current into the micro-electronic coil 23, magnetic moment may be generated on the gimbal frame 26, thereby providing magnetic torques on specific rotational axes. One of the magnetic torques provided by the gimbal frame 26 allows the gimbal frame 26 to rotate around the gimbal frame flexure suspension 27, thereby enabling the reflecting mirror 24 to rotate in the direction indicated by arrow S1, as depicted in FIG. 2. The other one of the magnetic torques provided by the gimbal frame 26 actuates the reflecting mirror 24 to operate in a resonance oscillation mode and to rotate around the reflecting mirror flexure suspension 25, thereby enabling the reflecting mirror 24 to rotate in the direction indicated by arrow S2, as depicted in FIG. 3.

During the operation of the 3D sensing system 100 according to an embodiment of the present invention, the MEMS controller 40 is configured to control the angle of the rotatable reflector plate 20. When the rotatable reflector plate 20 is rotating, the light modulation controller 50 is configured to control the light module 10 to emit light onto the MEMS scanning mirrors MEMS₁˜MEMS_{M} of the rotatable reflector plate 20, thereby reflecting the light provided by the light sources TX₁˜TX_{M} onto the target at a specific angle. The camera 30 is configured to take photos of each light spot present on the target for determining the distance of the target. When the target is closer to the reflector plate 20, the pitch of two adjacent light spots present on the target as a result of two light beams originated from a predetermined location and at a predetermined angle is smaller; when the target is farther away from the reflector plate 20, the pitch of two adjacent light spots present on the target as a result of two light beams originated from the predetermined location and at the predetermined angle is larger. The above-mentioned pitch may be recorded using the camera 30 and an algorithm may be used to calculate the distance between the light spots and the reflector plate 20 based on the recorded pitch and a predetermined look-up table.

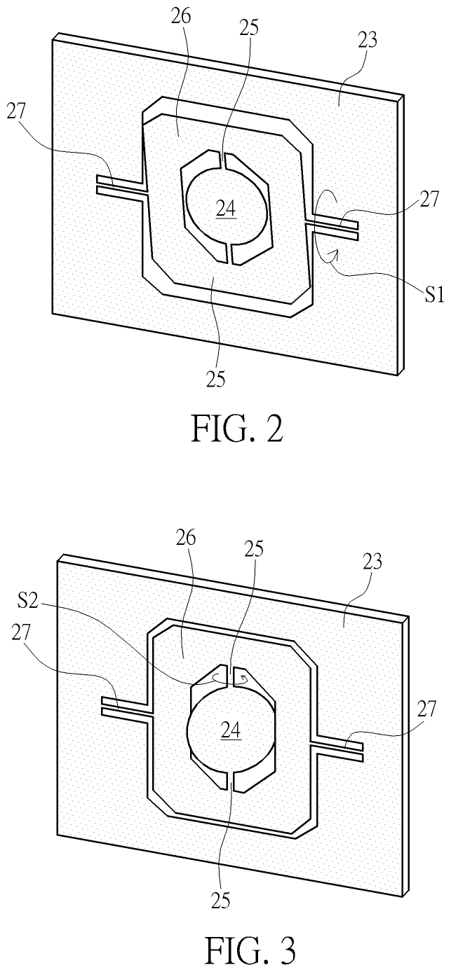

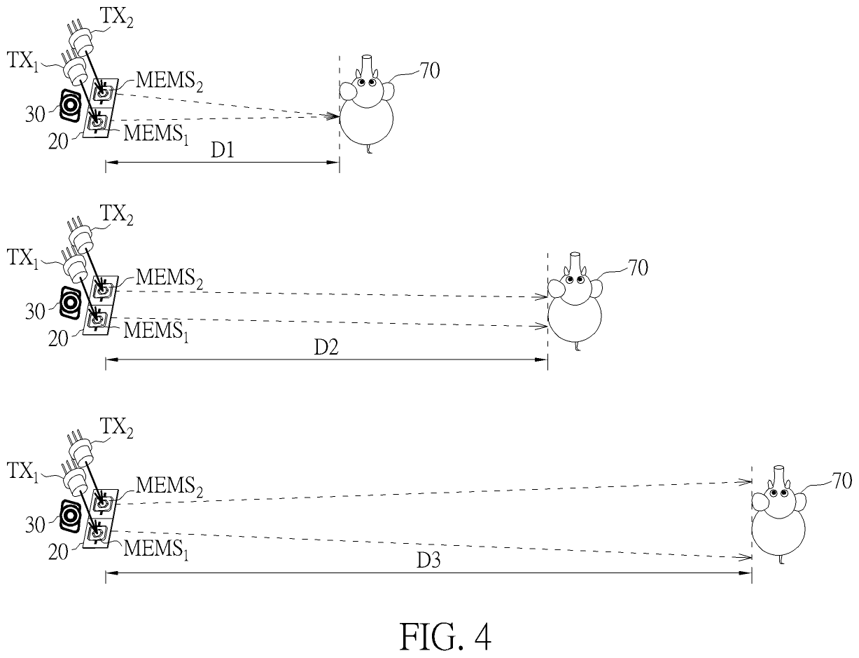

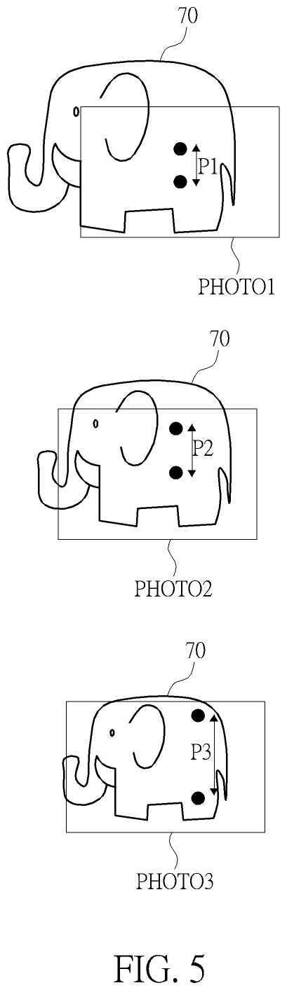

FIGS. 4-6 are diagrams illustrating the operation of the 3D sensing system 100 when determining distance based on the pitch of light spots according to an embodiment of the present invention. For illustrative purpose, FIGS. 4 and 5 depict an embodiment of M=2, wherein the light module 10 includes two light sources TX₁˜TX₂ and two MEMS scanning mirrors MEMS₁˜MEMS₂ are disposed on the rotatable reflector plate 20. The MEMS scanning mirrors MEMS₁˜MEMS₂ are configured to reflect the light provided by the light sources TX₁˜TX₂ onto a target 70 at a specific angle. From top to bottom, FIG. 4 depicts the scenarios when the distance between the target 70 and the reflector plate 20 is equal to D1˜D3, wherein D1<D2<D3. Meanwhile, the photos taken by the camera 30 can record the light spots caused by incident light of the target 70. From top to bottom, FIG. 5 depicts the photos PHOTO1˜PHOTO3 taken by the camera 30 when the distance between the target 70 and the reflector plate 20 is equal to D1˜D3, respectively, wherein the two light spots present on the target 70 as a result of the MEMS scanning mirrors MEMS₁˜MEMS₂ reflecting the light provided by the light sources TX₁˜TX₂ are designated by solid circles. The values of the pitches P1˜P3 of two adjacent light spots are inversely proportional to the distance between the target 70 and the reflector plate 20 (P1>P2>P3).

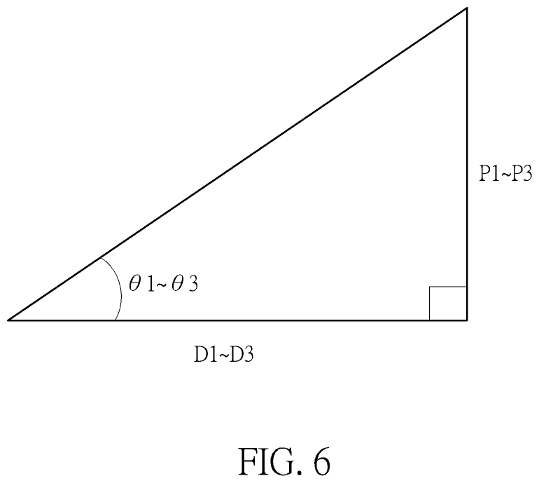

Based on the pitches of the light spots recorded by the photos taken by the camera 30, the MCU 60 may calculate the distance between the target 70 and the reflector plate 20. As depicted in FIG. 6, since the emission angle θ₁—θ₃ of the MEMS scanning mirrors MEMS₁˜MEMS₂ are known factors, the MCU 60 may acquire the values of D1˜D3 using trigonometric functions when recording the pitches P1˜P3 associated with different distances D1˜D3 of the target 70, wherein D1=cotθ1/P1, D2=cotθ2/P2 and D3=cotθ3/P3.

In an embodiment of the present invention, the correspondence of the emission angle of the MEMS scanning mirrors, the pitch of light spots, and the distance of a target may be pre-calculated and stored as a lookup table in the MCU 60, thereby increasing computation efficiency. However, the method of calculating the distance of a target based on different pitches does not limit the scope of the present invention.

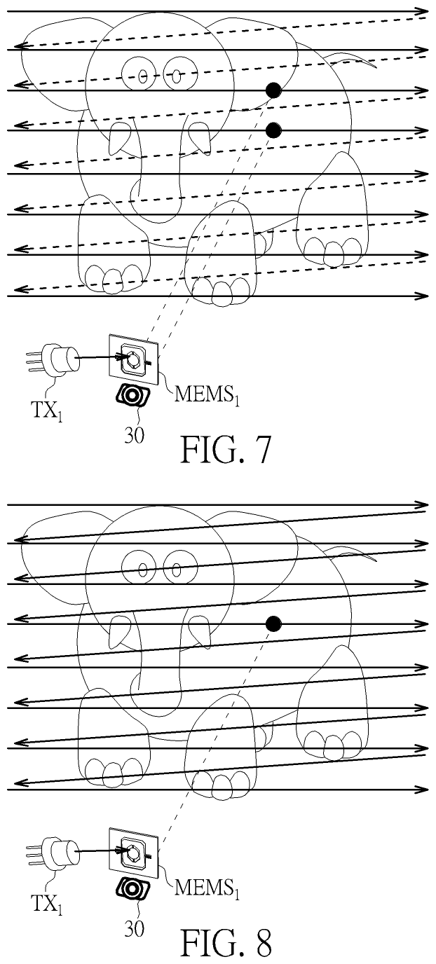

FIGS. 7-10 are diagrams illustrating the scan method of the 3D sensing system 100 according to embodiments of the present invention. For a specific scan plane of the rotatable reflector plate 20, a vertical axis and a horizontal axis are defined based on scan timing and scan sequence in the present invention. In FIGS. 7-10, the movement of the rotatable reflector plate 20 is indicated by arrows, wherein the solid arrows represent the actual scan lines when the light module 10 is emitting light and the dotted arrows represent the movement of the rotatable reflector plate without scanning (the light module 10 is off).

FIG. 7 depicts the embodiment in which a single laser light source TX₁ and a single MEMS scanning mirror MEMS₁ are used to perform uni-directional scans. After scanning from the start point to the end point of a current scan line, the rotatable reflector plate 20 is configured to move from the end point of the current scan line to the start point of a subsequent scan line without scanning (indicated by the dotted arrows) and then resume scanning from the start point to the end point of the subsequent scan line. FIG. 8 depicts the embodiment in which a single laser light source TX₁ and a single MEMS scanning mirror MEMS₁ are used to perform bi-directional scans. After scanning from the start point to the end point of a current scan line, the rotatable reflector plate 20 is configured to continue scanning from the end point of the current scan line to the start point of a subsequent scan line (indicated by the solid arrows).

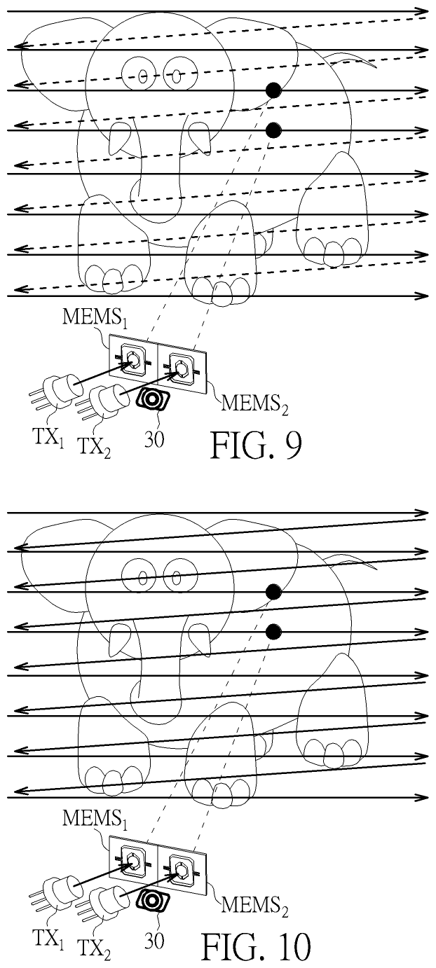

FIG. 9 depicts the embodiment in which multiple laser light sources TX₁˜TX_{M} and multiple MEMS scanning mirror MEMS₁˜MEMS_{M} are used to perform uni-directional scans. After scanning from the start points to the end points of M adjacent scan lines, the rotatable reflector plate 20 is configured to move from the end points of the current M adjacent scan line to the start points of the subsequent M adjacent scan lines without scanning (indicated by the dotted arrows) and then resume scanning from the start points to the end points of the subsequent M adjacent scan lines. FIG. 10 depicts the embodiment in which multiple laser light sources TX₁˜TX_{M} and multiple MEMS scanning mirror MEMS₁˜MEMS_{M} are used to perform bi-directional scans. After scanning from the start points to the end points of M adjacent scan lines, the rotatable reflector plate 20 is configured to continue scanning from the end points of the current M adjacent scan lines to the start points of the subsequent M adjacent scan lines (indicated by the solid arrows). For illustrative purpose, FIGS. 9 and 10 depict the embodiment when M=2. However, the value of M does not limit the scope of the present invention.

In the embodiments illustrated in FIGS. 7-10, solid circles represent the light spots as a result of the light provided by the light module 10 is reflected onto the target at a specific angle, wherein the distance between two adjacent light spots is required in order to calculate the value of the pitch. In FIGS. 7 and 8 which depict the embodiment adopting a single laser light source and a single MEMS scanning mirror, since the camera 30 can only record the location of a single light spot at each shot, the MCU 60 is configured to perform image synthesis by compositing the photos taken by the camera 30 at multiple points of time, thereby acquiring the pitch of two adjacent light spots. In FIGS. 9 and 10 which depict the embodiment adopting multiple laser light sources and multiple MEMS scanning mirrors, since the camera 30 can record the locations of multiple light spots at each shot, the MCU 60 is able to acquire the pitch of two adjacent light spots directly from a single photo. Therefore, the embodiment adopting a single laser light source and a single MEMS scanning mirror depicted in FIGS. 7 and 8 can reduce the amount of hardware, while the embodiment adopting multiple laser light sources and multiple MEMS scanning mirrors depicted in FIGS. 9 and 10 can provide high-speed and high-resolution scans.

Meanwhile, when performing 3D measurement in real world, there are usually multiple objects present in the background. Therefore, before the 3D sensing system 100 performs a 3D scan, the camera 30 may take an initial photo, based on which the MCU may determine a scan range.

In an embodiment, the MCU 60 is configured to identify all objects present in the background by analyzing the initial photo, and then set the scan range to a minimum range which includes one or more main objects in the background, thereby shortening the scan time. In another embodiment, the user may select one or more objects for scanning from the initial photo, and the MCU 60 may then set the scan range to a minimum range which includes the one or more user-selected objects, thereby shortening the scan time.

After setting the scan range, the MCU 60 is configured to instruct the MEMS controller 40 to control the angel of the rotatable reflector plate 20 for performing a 3D scan within the scan range. The camera 30 may then take photos for recording the location of each light spot during the 3D scan. In an embodiment, the photos taken by the camera 30 during the 3D scan has the same resolution as that of the initial photo. In another embodiment, the photos taken by the camera 30 during the 3D scan has a different resolution than that of the initial photo.

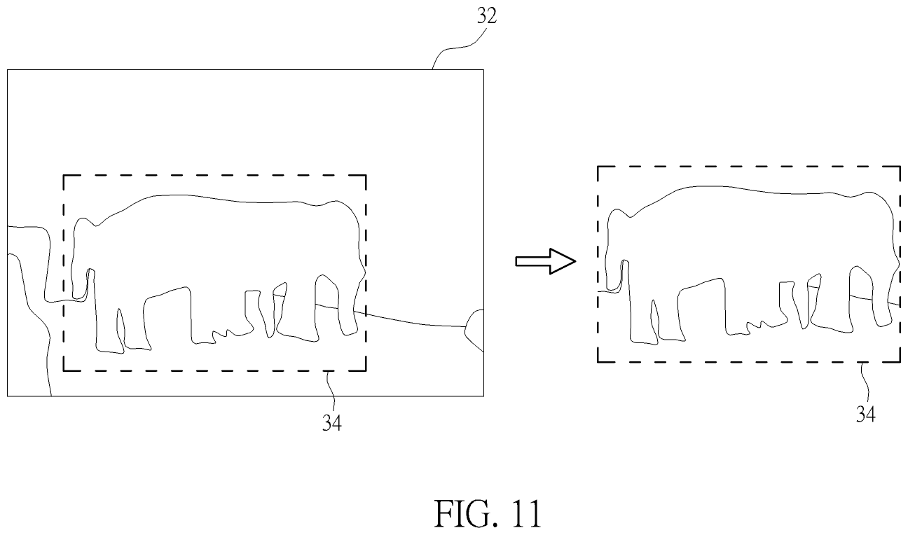

FIG. 11 is a diagram illustrating the operation of the 3D sensing system 100 when determining a scan range according to an embodiment of the present invention. Assuming that the original resolution of the camera 30 is 1920*1080, the MCU 60 is configured to determine a scan region 34 based on the initial photo 32 taken by the camera 30 so that the 3D sensing system 100 may perform a 3D scan using a 1920*1080 resolution within the scan range 34.

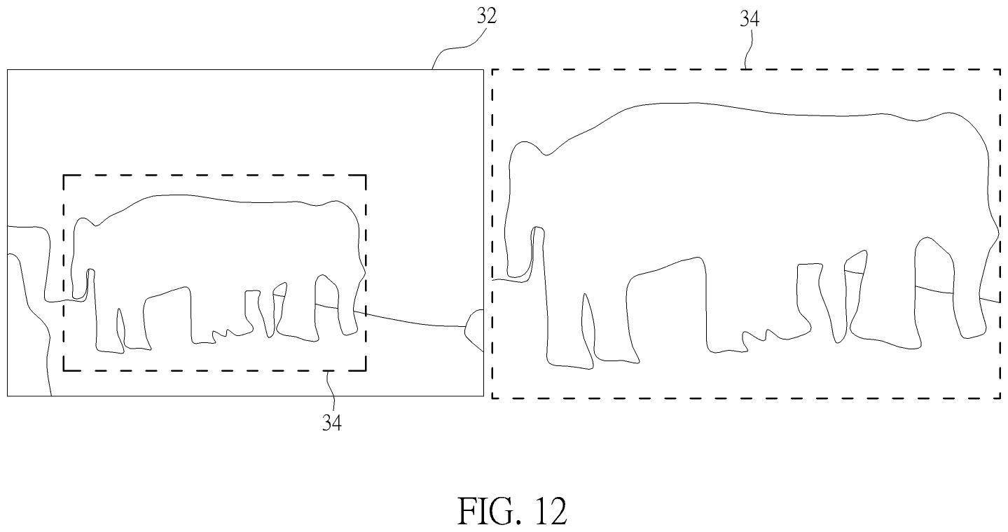

FIG. 12 is a diagram illustrating the operation of the 3D sensing system 100 when determining a scan range according to another embodiment of the present invention. Assuming that the original resolution of the camera 30 is 1920*1080, the MCU 60 is configured to determine a scan region 34 based on the initial photo 32 taken by the camera 30 so that the 3D sensing system 100 may perform a 3D scan using a higher resolution (such as 2560*1440) within the scan range 34.

In an embodiment of the present invention, the light sources TX₁˜TX_{M} of the light module 10 may be light emitting diodes (LED) or vertical cavity surface emitting lasers (VCSEL). However, the type of the light sources TX₁˜TX_{M} does not limit the scope of the present invention.

In conclusion, the present invention provides a 3D sensing system using MEMS technologies. Multiple MEMS scanning mirrors may be used for reflecting light onto a target and the resultant light spots may be recorded by a camera, thereby calculating the distance of the target according to the pitch of two adjacent light spots. The correspondence of the emission angle of light, the pitch of light spots, and the distance of a target may be pre-calculated and stored as a lookup table in an MCU of the 3D sensing system, thereby simplifying subsequent computation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A 3D sensing system, comprising:
a light module including one or multiple light sources;
a rotatable reflector plate including one or multiple micro electro mechanical (MEMS) scanning mirrors arranged to reflect light provided by the one or multiple light sources;
a camera configured to record one or multiple light spots present on a target when the light provided by the one or multiple light sources is reflected on the target; and
a micro controller unit configured to acquire a distance between the target and the rotatable reflector plate according to a pitch of two adjacent light spots among the one or multiple light spots.

2. The 3D sensing system of claim 1, wherein:
the light module includes one light source;
the rotatable reflector plate includes one MEMS scanning mirror arranged to reflect the light provided by the one light source;
the camera is configured to take a first photo at a first point of time for recording a first light spot present on the target when the light provided by the one light source is reflected on the target at the first point of time and take a second photo at a second point of time for recording a second light spot present on the target when the light provided by the one light source is reflected on the target at the second point of time; and
the micro controller unit is further configured to composite the first photo and the second photo for acquiring the pitch of the first light spot and the second light spot by.

3. The 3D sensing system of claim 2, further comprising:
an MEMS controller configured to control an angle of the rotatable reflector plate so that the one MEMS scanning mirror scans a plane having N parallel scan lines by scanning from a start point to an end point of each scan line sequentially, wherein N is an integer larger than 1.

4. The 3D sensing system of claim 2, further comprising:
an MEMS controller configured to control an angle of the rotatable reflector plate so that the one MEMS scanning mirror scans a plane having N parallel scan lines by scanning from a start point of an n^{th} scan line among the N parallel scan lines to an end point of the n^{th} scan line and then scanning from the end point of the n^{th} scan line to a start point of an (n+1)^{th} scan line among the N parallel scan lines, wherein N is an integer larger than 1 and n is a positive integer which does not exceed N.

5. The 3D sensing system of claim 1, wherein:
the light module includes a first to an M^{th} light sources;
the rotatable reflector plate includes a first to an M^{th} MEMS scanning mirrors arranged to reflect the light provided by the first to the M^{th} light sources;
the camera is configured to take a photo at a specific point of time for recording a first to an M^{th} light spots present on the target when the light provided by the first to the M^{th} light sources is reflected on the target at the specific;
the micro controller unit is further configured to acquire a first to an M^{th} distances respectively between M locations on the target and the rotatable reflector plate according to a first to an M^{th} pitches of each two adjacent light spots among the first to the M^{th} light spots; and
M is an integer larger than 1.

6. The 3D sensing system of claim 5, further comprising:
an MEMS controller configured to control an angle of the rotatable reflector plate so that the first to the M^{th} MEMS scanning mirrors scan a plane having N parallel scan lines by scanning from a start point to an end point of each scan line sequentially,
wherein N is an integer larger than M.

7. The 3D sensing system of claim 5, further comprising:
an MEMS controller configured to control an angle of the rotatable reflector plate so that the first to the M^{th} MEMS scanning mirrors scan a plane having N parallel scan lines by scanning from a start point of an n^{th} scan line among the N parallel scan lines to an end point of the n^{th} scan line and then scanning from the end point of the n^{th} scan line to a start point of an (n+1)^{th} scan line among the N parallel scan lines, wherein N is an integer larger than M and n is a positive integer larger which does not exceed N.

8. The 3D sensing system of claim 5, further comprising a light modulation controller configured to turn on or turnoff the light module, wherein the micro controller unit is further configured to synchronize operations of the camera, the MEMS controller and the light modulation controller.

9. The 3D sensing system of claim 1, wherein the micro controller is further configured to:
instruct the camera to take an initial photo;
analyze the initial photo for identifying one or multiple objects in the initial photo;
determine a scan range according to the target which is selected from the one or multiple objects;
adjust an angle of the rotatable reflector plate for the one or multiple MEMS scanning mirrors to perform a 3D scanning within the scan range.

10. The 3D sensing system of claim 9, wherein the micro controller unit is further configured to:
instruct the camera to take the initial photo using a first resolution; and
instruct the camera to take multiple photos using a second resolution higher than the first resolution when the one or multiple MEMS scanning mirrors are performing the 3D scanning within the scan range.

11. The 3D sensing system of claim 1, wherein the micro controller unit is further configured to:
instruct the camera to take an initial photo;
analyze the initial photo for identifying one or multiple objects in the initial photo;
determine a scan range according to the target which is selected by a user; and
adjust an angle of the rotatable reflector plate for the one or multiple MEMS scanning mirrors to perform a 3D scanning within the scan range.

12. The 3D sensing system of claim 11, wherein the micro controller unit is further configured to:
instruct the camera to take the initial photo using a first resolution; and
instruct the camera to take multiple photos using a second resolution higher than the first resolution when the one or multiple MEMS scanning mirrors are performing the 3D scanning within the scan range.
